(19) United States
(12) Patent Application Publication
(10) Pub. No.: US 2008/0040304 A1
(43) Pub. Date: Feb. 14, 2008

(54) Method for Modifying a Network Equipment Behavior

(76) Inventors: Guy Pujolle, Chatillon (FR); Dominique Gaiti, Paris (FR)

Correspondence Address: JACOBSON HOLMAN PLLC, 400 SEVENTH STREET N.W., SUITE 600, WASHINGTON, DC, 20004, US

(21) Appl. No.: 11/660,409

(22) PCT Filed: Aug. 16, 2005
(86) PCT No.: PCT/FR05/02089

§ 371 Date: Apr. 24, 2007

(30) Foreign Application Priority Data
Aug. 16, 2004 (EP) 04292054.6

(51) Int. Cl. G06F 17/00

(52) U.S. Cl. 706/46

(57) ABSTRACT

The invention concerns a method for modifying the behaviour of a network equipment (1, 4, 20) through data exchange within said equipment (1, 4, 20) between said network equipment (1, 4, 20) and a management member (11) provided in said network equipment (1, 4, 20). The invention is characterized in that said management member (11) is connected to an intelligent agent (13) included (13) in said network equipment (4, 20), said intelligent agent (13) being capable of performing reasoning, communicating and battery functions.

The present invention relates to a method able to make network hardware proactive.

The definition of a proactive system is a system whose behavior can adjust and adapt in real-time according to its environment, in a way that is not pre-programmed but is deduced by logical reasoning, exchange and learning based on data that is identified, recognized and taken on.

Reasoning functions are functions that enable a system to establish deductions based on knowledge present within that system.

Learning functions are functions that enable a system to categorize the knowledge it holds in order to deduce new reasoning functions that will enable it to deduce new knowledge.

Exchange functions are functions that enable a system to communicate, either with the network hardware assigned to it, or with outside the system, which is known as the system environment, or with other intelligent agents within its environment.

A proactive object therefore possesses a driver or a controller that enables the object to possess the features described above that will confer it the ability to adjust its actions according to its outside environment and according to its own reasoning.

A proactive system is therefore able to reason, adjust, and take decisions according to changes in said system and its environment.

Network hardware, for example a router, a function box or a firewall, is designed to fulfill certain functions as it routes blocks of information, functions such as routing, deleting, queuing or changing priority of these blocks of information.

The blocks of information can be packets, frames or any other unit block of binary information that contains data that needs to be carried from the sender to the receiver. To simplify this description, these blocks of data will be called packets throughout the rest of this description.

The method according to the invention applies to any kind of network hardware that posses packet processing functions, for example to routers, in particular consumer routers, business routers, ADSL, gigabit routers, terabit routers, to switches, in particular peripheral switches, infrastructure switches, multicast routers or agency routers, to switch routers, in particular LSP (Label Switch Routers) or control boxes, in particular firewall boxes, appliances, etc.

An information exchange network is built of a wide range of network hardware able to carry packets from a sender to a receiver.

Network hardware conventionally posses a handful of fundamental actions it can perform to control the data transfer from an input port to an output port.

These fundamental actions are, for example, packet refusal, packet rerouting, packet priority changing, queuing, etc.

Network hardware takes decisions on these fundamental actions based on information in the local network hardware and therefore does not take into account events external to the network hardware itself, for example the environment, or user profiles, or the condition of other hardware in the network, and the data traffic passing through.

This decision-making therefore relies on static decisions, which means that the same event in the same context will always trigger the same reaction.

It is known, according to the document entitled “Dynamic Network Adaptation Techniques in an open network environment: conference on IT and communications at the dawn of the new millennium (AIT2000)” by Marshall A. et al, (1 Aug., 2000, pages 1 to 10), that there are information exchange methods that can make network hardware reactive (but not proactive), i.e. that it is necessary to invoke routing determination in order to route data packets. According to this embodiment, dynamic adaptations of network hardware can be achieved through outside intervention, either from the user, a service provider, or the operator.

It is the object of the present invention to make these decisions dynamic using a method able to make network hardware proactive in order to obtain an exchange network able to adapt to a whole range of conditions and observations that are recognized or learned by experience and that can anticipate certain actions autonomously.

The invention method therefore makes it possible for network hardware to remember and apply certain actions that are adapted to certain conditions that will have been observed, recognized and (or) learned.

The invention method can also be used to create a network able to anticipate network congestion, packet routing delays, breakdowns in transfer nodes, link breaks or hacker attacks.

The present invention covers a method for modifying the behavior of a network hardware component using data exchanges within the network between said network hardware component and a controller built into said network hardware, wherein the controller is linked to an intelligent agent bundled with the network hardware, said intelligent agent being able to perform reasoning functions, communication functions, learning functions, autonomy functions, as well as recognition functions.

In an advantageous implementation of the method according to the invention, the intelligent agent can build a multi-agent system, either as a reactive agent or as a cognitive agent, that is continuously linked to the controller and that comprises intelligent sub-agents each linked to the controller, said intelligent sub-agents being able to take non-static decisions and being linked to the controller via an interface through which primitives are processed.

The intelligent agent can advantageously communicate with the controller via an interface that can be used to manage the exchange of configuration primitives.

The present invention will now be described using examples that are solely illustrative and in no way limiting in terms of the scope of the invention, based on the attached illustrations, in which:

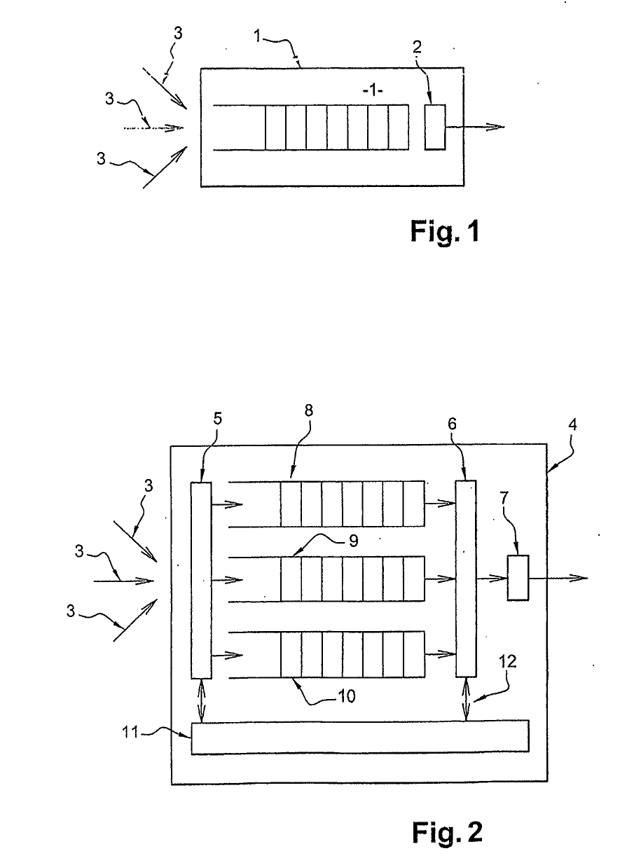

FIG. 1 illustrates the operating mode of a first-generation router;

FIG. 2 illustrates the simplified operating mode of a second-generation router;

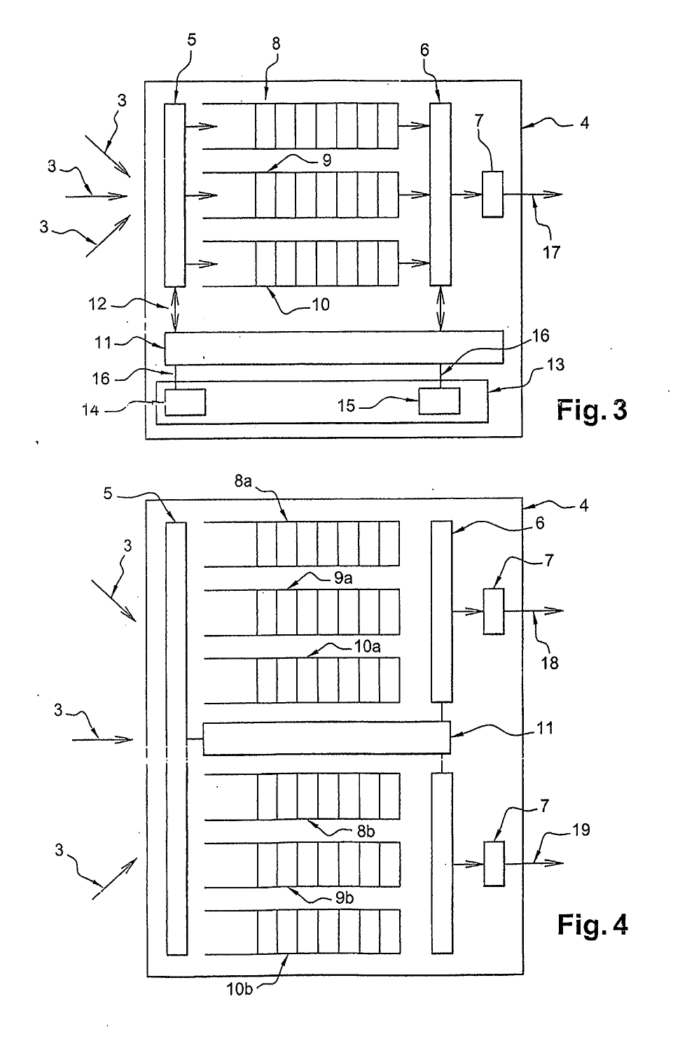

FIG. 3 illustrates the operating mode of a second-generation router made proactive through the method according to the invention;

FIG. 4 illustrates the operating mode of a second-generation router in which two outgoing lines are available;

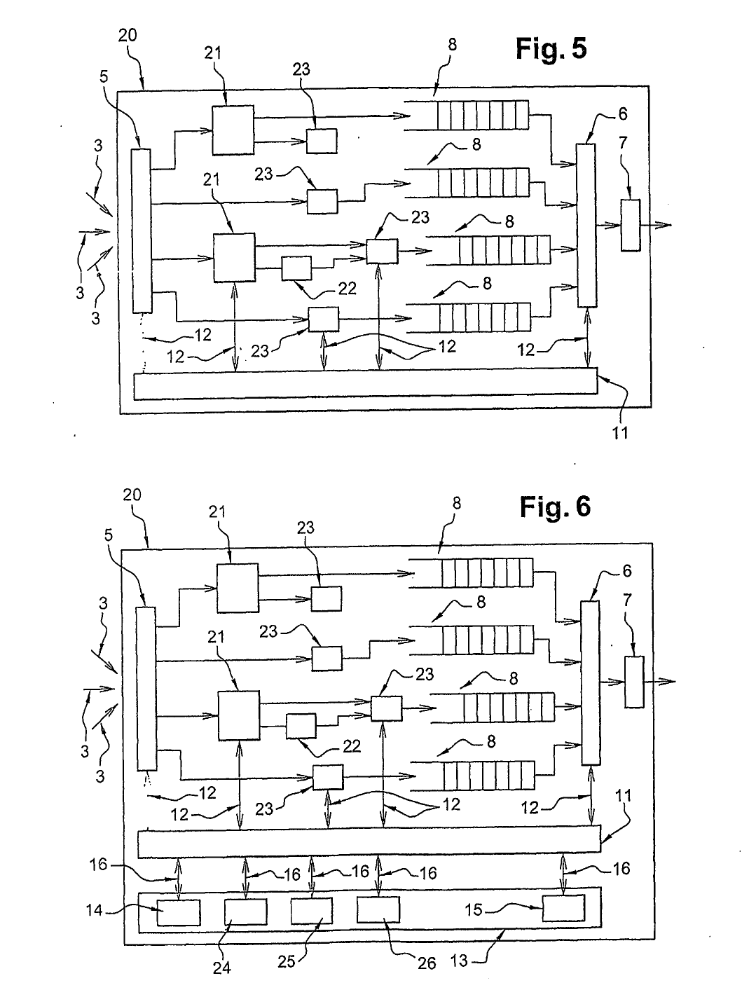

FIG. 5 illustrates the operating mode of a third-generation router;

FIG. 6 illustrates the operating mode of a third-generation router made proactive through the method according to the invention;

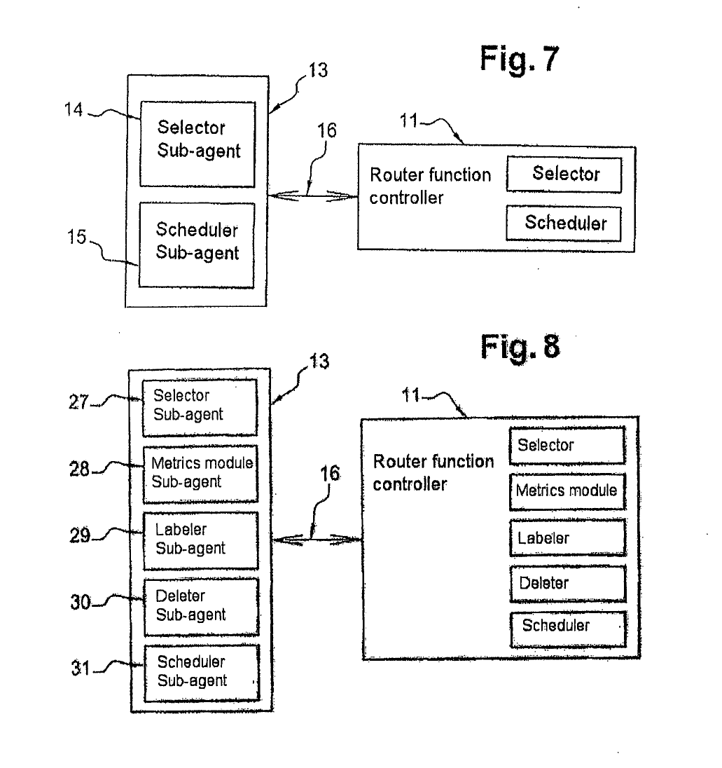

FIG. 7 is a schematic illustration of the operating mode showing data exchanges between an intelligent agent (13) and a controller (11) of a router made proactive through the method according to the invention;

FIG. 8 is a schematic illustration of a second operating mode showing data exchanges between an intelligent agent (13) and a controller (11) of router made proactive through the method according to the invention;

FIG. 1 gives a schematic overview of the operating mode of a first-generation router (1), which is known to those skilled in the art.

Although the following description has been simplified by referring to a data transfer node in the form of a router, it is understood that the method according to the invention can be applied to any transfer component that possessed functions implemented during packet routing.

The router is part of a data exchange network that works by exchanging data packets.

The actions taken by the network transfer node are conventional actions, namely packet refusal, packet time-outs, packet acceleration, rerouting, etc.

The first-generation router (1) presents a transmission interface (2) able to transmit the different data packets received via input ports (3) towards another transfer component, for example another router.

FIG. 2 gives a schematic overview of the operating mode of a second-generation router (4) in a simplified operating mode that does not include the routing function.

The second-generation router (4) has data packets at input ports (3), which enter a known selector (5).

The definition of a selection module is a component that selects a queue leading to a specific handling process.

The output port of second-generation router (4) has a known scheduler (6) and transmission interface (7), which is also known.

The definition of a scheduler is a component that chooses the queue to be served, and an interface is the link between two components that enables information to be exchanged.

More precisely, the selection module (5) is able to select incoming data packets at input ports (3) according to, for example, the IP address of the recipient, the protocol encapsulated in the packet, features derived from IP packet fields, or any other characteristic identified by the router.

The selection module (5) then statically positions the data packets in one of the queues (8, 9, 10) leading to scheduler (6).

The definition of a queue is a component that is able to memorize clients in a specific order.

Scheduler (6) thus decides which of the packets is to be transferred to the next router, this decision being static, i.e. only taking account of an algorithm installed in the router by the router manufacturer.

Scheduler (6) is able to use several algorithms, and especially the widely used algorithm Weighted Fair Queuing (WFQ), which assigns a priority to each queue (8, 9 10), or the Weighted Random Early Detection (WRED) which labels or blocks packets according to the number of packets present in the buffer memory resources of the router.

Only one algorithm is installed in conventional routers. In proactive routers, several algorithms can be available and executed in real time.

The router has a known router function controller(1 1).

The definition of a controller (11) is a component able to configure material and software in hardware, for example a router.

An operational controller (11) is either directly programmed by a network engineer or is given configuration instructions by remote means. These configuration instructions adapt the hardware or software following the instructions given.

For example, if the instruction is to assign all the packets carrying a certain IP address into the most high-priority queue, then the controller (11) configures the hardware or software to examine the packets accordingly, in such a way that if the packet's destination address matches exactly, then the packet will be routed into the most high-priority queue.

Controller (11) can advantageously comprise a processor and memory and is able to configure selection module (5) and scheduler (6).

Selection module (5) and scheduler (6) are both globally linked to controller (1), which sends them configuration primitives via an interface (12).

FIG. 3 gives a schematic overview of the operating mode of a second-generation router (4) made proactive through the method according to the invention.

The same entities as in FIG. 2 are annotated with the same reference numbers.

Router controller (11) is linked to an intelligent system agent (13), this proactive system feature (13) comprising two intelligent sub-agents (14, 15) which are in turn linked to controller (11), itself linked to selection module (5) and scheduler (6).

The Intelligent agent (13) is included in router (4).

In an advantageous embodiment, the pair of intelligent sub-agents (14, 15) is able to take non-static configuration decisions according to their own perception capabilities at a given moment in time.

More precisely, the two intelligent sub-agents (14, 15) are intelligent sub-agents able to make real-time decisions involving the selection of packets arriving at selection module (5) and the scheduling of data packets channeled through the queues (8, 9, 10) and arriving at scheduler (6), again via controller (1 1).

The intelligent agent (13) is able to communicate with router function controller (11) via an interface (16) that can be used to manage the exchange of configuration primitives.

Router (4) according to FIG. 3 has a single output port (17), it being understood that router (4) can have as many output ports as may be required.

FIG. 4 illustrates a second-generation router(4) in which two outgoing lines (18, 19) are available. This router has a routing function enabling it to choose between outgoing lines (18) and (19).

The second-generation router contains a router function controller component (11), as described above, but here also configuring, in addition to the entities indicated previously, the entities handling the routing.

FIG. 5 is an illustration of a simplified embodiment of third-generation router (20) handling only one output line. It would be extended to incorporate the routing function as explained previously for FIG. 4 compared to FIG. 2.

The third-generation router (20) has data packets at input ports (3) that enter a known selector (5). Once the selection process is done, the data packet can be forwarded through components such as metrics module (21), labeler (22), deleter (23) and queue (8), which are all know entities.

The output port of third-generation router (20) has a known scheduler (6) and transmission interface (7), which is also known.

The definition of metrics module (21) is an entity capable of measuring certain characteristics of data traffic, such as the time lapse between the arrival of two data packets.

The definition of a labeler (22) is an entity capable of attaching or changing a label within a data packet, for example a handling priority label.

The definition of a deleter (23) is a component able to delete a packet.

The router has a known router function controller(1 1).

For example, if the instruction determines the time elapsed since the last packet handled, to delete all the packets carrying a certain IP address, or to change a packet label, then the controller (11) configures the router hardware or software so that it can perform these tasks.

The selector (5), scheduler (6), metrics modules (21), labelers (22) and deleters (22) are all connected to the controller (11), which sends them configuration primitives via interface (12).

FIG. 6 gives a schematic overview of the operating mode of a third-generation router (20) made proactive through the method according to the invention.

The same entities as in FIG. 3 are annotated with the same reference numbers.

Router controller (11) is linked to an intelligent system agent (13), this proactive system feature (13) comprising five intelligent sub-agents (14, 15, 24, 25, 26) which are in turn linked to controller (11), itself linked to selector (5), scheduler (6), metrics modules 21, labelers (22) and deleters (23).

The Intelligent agent (13) is included in router (20).

In an advantageous embodiment, the five intelligent sub-agents (14, 15, 24, 25, 26) are able to take non-static configuration decisions according to their own perception capabilities at a given moment in time.

More precisely, the five intelligent sub-agents (14, 15, 24, 25, 26) are intelligent sub-agents able to make real-time decisions involving the selection of packets arriving at selector (5), the scheduling of data packets channeled through the queues (8, 9, 10) and arriving at scheduler (6), parameters to be measured by the metrics modules (21), the labeling tasks to be carried out by the labelers (22) and the packets to be deleted by the deleters (23), again via the controller.

The definition of an intelligent agent is a software agent able to perform perception functions, reasoning functions, learning functions, and communication functions, whether autonomously or not.

The definition of perception functions covers functions that enable the system to understand the condition of its environment and any changes in the environment's condition, and to conserve this data in a form that can be used later on.

Similarly, autonomous functions are functions that enable the system to carry out a certain number of tasks without human and (or) outside intervention. These tasks are learnt directly, by the system itself.

An intelligent agent can be any kind of agent, such as for example a reactive agent, which is known, or a cognitive agent, which is known, or any other kind of intelligent agent that can be used to build a multi-agent system, i.e. a set of agents working together to achieve the same goal.

The term ‘multi-agent system’ is understood to be a system that harnesses together intelligent agents of various types and capacities, said agents cooperating together and coordinating their actions, either intentionally or otherwise, in order to achieve the same objective.

The definition of a reactive agent is an intelligent agent based on the condition-action rule. The agent reacts to each perceived input and triggers an action. This reaction does not draw on explicit knowledge.

Similarly, the definition of a cognitive agent is an agent that takes input data and proceeds to process this data using knowledge that is possesses or has learnt in order to deduce the most suitable action.

Intelligent sub-agents (14, 15, 24, 25, 26) are connected to controller (11) by interface (16) through which transit primitives, i.e. specific messages that they exchange.

The method according to the invention is based on connecting a router to an intelligent agent (13) that is linked via a continuous link to a router function controller, where said intelligent agent (13) can be built of basic agents carrying out tasks for the intelligent agent (13). The continuous link between intelligent agent (13) and controller (11) means that intelligent agent (13) is a permanent resident in the network hardware.

An intelligent agent (13) can be any kind of agent, such as for example a reactive agent, which is known, or a cognitive agent, which is also known, or any other kind of intelligent agent that can be used to build a multi-agent system, i.e. a set of agents working together to achieve the same goal.

The agent can perform all the tasks in the process, or else it can be built of several agents that perform tasks linked to specific functions and that, taken together, form the intelligent agent. The choice of the number of subagents used is governed by the performances to be achieved, the number of functions to be implemented, any breakdown of functions into sub-functions, etc.

FIG. 7 is a schematic illustration of the operating mode showing data exchanges between an intelligent agent (13) and a controller (11) of a router made proactive through the method according to the invention.

According to FIG. 7, it has been supposed that the intelligent agent (13) is built of two sub-agents: the selector subagent (14) and the scheduler sub-agent (15), these two subagents (14, 15) together forming the intelligent agent (13).

The intelligent agent (13) continuously receives data from other routers in the exchange network. Together with the intelligent agents in all the hardware of the global network, they form a multi-agent system.

The intelligent agent (13) is able to communicate with router function controller (11) via an interface (16) that can be used to exchange configuration primitives.

FIG. 8 is a schematic illustration of a second operating mode showing data exchanges between an intelligent agent (13) and a controller (11) of a router made proactive through the method according to the invention.

According to FIG. 8, it has been supposed that the intelligent agent (13) is built of five sub-agents: subagent (27) of selector (5), subagent (31) of scheduler (6), subagent (28) of metrics module (21), subagent (29) of labeler (22) and subagent (30) of deleter (23), all five subagents (27, 28, 29, 30, 31) together forming intelligent agent (13). The intelligent agent (13) communicates with router function controller (11) via an interface (16) that can be used to exchange configuration primitives.

The intelligent agent (13) continuously receives data from the other routers. Together with the intelligent agents in all the hardware of the global network, they form a multi-agent system.

The invention method consists of a continuous link-up between intelligent agent (13) and router function controller (1 1).

However, in an alternative implementation, the intelligent agent (13) can be directly associated with selector (5), scheduler (6), metrics module (21), labeler (22) and deleter (23), and not to controller (11).

The intelligent agent (13) can advantageously manage series of thresholds S1, S2, S3 to Sn.

For example, it is considered that a series of two value thresholds S1 and S2 defines the following behavior:—if the condition does not exceed threshold value S1, then the agent takes no decision,—if the conditions exceeds threshold value S1 but remains below S2, the agent takes a decision that is transmitted to the router function controller via a configuration primitive.

If the condition exceeds threshold value S2, then the intelligent agent (13) sends a new configuration primitive to controller (11).

Similarly, when the thresholds are passed going down, configuration primitives are sent to controller (11).

Threshold value S1 can, for example, be average loading of the network's router memory, equal to 50% of the totally available memory resources.

Threshold value S2 can, for example, be average loading of the network's router memory equal to 80%.

It is possible to define far more complex threshold values drawing on several parameters.

Threshold values S1 and S2 are in fact defined dynamically by the intelligent agent (13) according to its knowledge.

The primitives indicate the algorithm to be implemented (WFQ, WRED, etc.) and give parameter values to enable controller (11) to configure selector (5) and scheduler (6).

The method according to the invention can advantageously be used to automatically configure routers according to the decisions made by the intelligent agent and the network hardware control orchestrated by the intelligent agent, which makes them proactive.

As a further example, and again considering that intelligent agent (13) manages the series of threshold values S1, S2, S3 to Sn, we can take the hypothesis that, if n=3, the series S1, S2 and S3 defines the following behavior: if the router condition either exceeds or falls below a threshold, then intelligent agent (13) sends a configuration primitive to controller (11), these threshold values being determined dynamically by the intelligent agent according to its knowledge base and the reasoning it is able to apply to this knowledge.

For example, S1 is determined by the rate of inputs into the router, equal to 40% of the capacity of the incoming lines.

For example, threshold S2 is given a value of 60% of the capacity of the outgoing lines and threshold S3 has a value of 80% and at a loading of the node's memory of at least 70%.

The primitives indicate an algorithm to be implemented and give parameter values to enable controller (11) to configure selector (5), and scheduler (6), metrics module (21), labeler (22) and deleter (23), and any other component of a router.

The parameters values can, in the event of the threshold S1 being crossed, be: the deletion of all data packets of lowest priority; if threshold value S2 is crossed: the deletion of all data packets of priority 2, and if threshold value 3 is crossed: the deletion of all data packets of the highest priority that are not word packets.

1. A method for modifying the behavior of a network hardware component using data exchanges within the network between said network hardware component and a controller built into said network hardware, wherein the controller is linked to an intelligent agent bundled with the network hardware, said intelligent agent being able to perform reasoning functions, communication functions, learning functions and autonomous functions.

2. The method of claim 1, wherein said intelligent agent performs recognition functions.

3. The method of claim 1, wherein said intelligent agent is an element of a multi-agent system.

4. The method of claim 1, wherein said intelligent agent is a reactive agent.

5. The method of claim 1, wherein said intelligent agent is a cognitive agent.

6. The method of claim 1, wherein said intelligent agent is continuously linked to the controller.

7. The method of claim 1, wherein said intelligent agent comprises intelligent sub-agents each linked to the controller.

8. The method of claim 7, wherein said intelligent sub-agents are able to take non-static decisions.

9. The method of claim 7, wherein said intelligent sub-agents are linked to the controller via an interface through which primitives are processed.

10. The method of claim 7, wherein the intelligent agent communicates with said controller via an interface allowing the exchange of configuration primitives.
